(19) United States
(12) Patent Application Publication
(10) Pub. No.: US 2012/0143462 A1
(43) Pub. Date: Jun. 7, 2012

(54) ENGINE HAVING SUPERCHARGED INTAKE SYSTEM WITH CDA VALVE SYSTEM/ARRANGEMENT AND METHODS RELATED THERETO

(75) Inventor: Yong Woo Kim, Canton, MI (US)

(73) Assignees: HYUNDAI MOTOR COMPANY, Seoul (KR); HYUNDAI AMERICA TECHNICAL CENTER, INC., Superior Township, MI (US); KIA MOTORS CORPORATION, Seoul (KR)

(21) Appl. No.: 12/961,495

(22) Filed: Dec. 7, 2010

(51) Int. Cl. F02D 43/00; F02D 28/00; F02D 17/02

(52) U.S. Cl. 701/102; 123/559.1; 123/559.3

(57) ABSTRACT

Featured is a method for controlling operation of an internal combustion engine having a supercharger, a bypass, a cylinder de-activation (CDA) system and a throttle body, where the supercharger is configured and arranged so as to be selectively operable. Such a method includes determining which of three operating modes is appropriate for a given set of operating conditions and controlling each of the supercharger, the bypass, the CDA system and the throttle body based on the determined operating mode. In the first and second operating modes, the supercharger is not operable and the bypass is opened. In the third mode, the supercharger is operable and the bypass is closed. In the first and third modes, the CDA system is configured so all cylinders are operational. In the second mode, the CDA system is configured so certain cylinders are in a deactivated state and so other cylinders remain operable.

### FIELD OF INVENTION

The present invention relates to combustion engines having an intake system including a supercharger and a valve arrangement/system embodying cylinder de-activation (CDA) techniques and methods related thereto. The present invention also relates to such intake systems where the supercharger embodies a clutch for selectively controlling operation of the supercharger and an air bypass. Additionally, the present invention also relates to such intake systems and valve arrangements/systems that are controlled so the engine has three different operating modes.

### BACKGROUND OF THE INVENTION

It is known in the art relating to automotive or internal combustion engines to use various means to obtain peak torque and power. Among the various devices designed, tuned or set to provide the optimum engine performance are the engine camshaft, fixed or variable valve timing means, an air intake system including manifold plenums and runners, an exhaust system, and a supercharger. Generally, engine design or tuning is optimized to obtain peak torque at a relatively high speed, which generally provides a lower level of volumetric efficiency and torque at lower engine speeds.

There is shown in FIG. 1 a supercharger that is operably coupled to the crank shaft of an internal combustion engine by means of a belt. In this way, a portion of the rotational energy developed by the engine is used to drive the supercharger and consequently increase air charging. In more particular embodiments, the belt is operably coupled to the supercharger by a clutch so that the supercharger can be selectively coupled and decoupled to the engine. In this way, the engine can be run in one of two modes. In one mode; the normally aspirated mode (NA mode) the supercharger is not boosting or increasing the air charge, but rather the engine is being operated normally aspirated. In the second mode, the supercharged mode (SC mode), the supercharger is operating which in turn boosts or increases the air pressure. Such a supercharger type of application also is found in U.S. Pat. No. 4,527,534 and U.S. Pat. No. 7,353,699.

In one well known technique to increase vehicle fuel efficiency, internal combustion engines have been modified for operation with cylinder deactivation (CDA), also referred to as

Displacement on Demand (DOD). When using CDA, the engine is powered by less than all of the cylinders, generally not less than half, while the remaining cylinders are deactivated by closing their valves and shutting off their fuel supply. For example, there is shown in FIGS. 2A, B illustrative views of an cylinder block 10 for a V-8 engine, with the cylinder heads removed for clarity that shows 8 cylinder or standard (STD) operation (FIG. 2A) in which all eight cylinders 12 develop power. CDA operation is shown in FIG. 2B, where four cylinders 12a are deactivated and four cylinders 12b remain operational. The operational cylinders are highlighted by means of an asterisk.

Inherently, CDA or DOD operation is limited to a lower range of torque loads than standard (STD) operation with all cylinders activated. Thus, when quick vehicle acceleration or high speed operation is called for, the engine typically is automatically switched over to standard (STD) operation to provide the necessary torque or power. This reduces fuel efficiency because the cylinder loading is reduced to a less efficient level than could be maintained if the engine could continue with DOD operation.

There is found in US Patent Publication No. 2005/0279320 and U.S. Pat. No. 6,874,463, internal combustion engines which embody such cylinder deactivation techniques. In U.S. Pat. No. 6,874,463, it is further described that the intake system of the engine using the described cylinder deactivation techniques can be configured so as to include a supercharger, more specifically a turbocharger. In such a system, the turbocharger is used when the cylinders are deactivated so as to increase the amount of air and fuel in the other non-deactivate or standard (STD) cylinders.

According to another technique, the volumetric efficiency of the engine is improved by forcing more air and fuel into each cylinder such as by using a supercharger or a turbocharger. In other words, the intake system is configured and arranged so the incoming air is compressed by the supercharger or the turbocharger, thereby increasing the amount of oxygen that is available in each cylinder for combustion. As the amount of oxygen is being increased, the amount of fuel being introduced into each cylinder also can be increased so that the power produced per cylinder is increased correspondingly.

While CDA/DOD or supercharging have been used to increase volumetric efficiency of an internal combustion engine, these techniques are limited to use in different operational regions of the internal combustion engine as well as having operational constraints to avoid use outside of these operational regions.

It thus would be desirable to provide a new system for improving the volumetric efficiency of an internal combustion engine and methods related thereto. It would be particularly desirable to provide such a device and method that would improve volumetric efficiency over a wide range of typical operational or operating bands of the engine.

### SUMMARY OF THE INVENTION

The present invention features a method for controlling operation of an internal combustion engine having a supercharger, an air bypass, a cylinder de-activation (CDA) system and a throttle body, where the supercharger is configured and arranged so as to be selectively operable. Such a method includes determining which of three operating modes is appropriate for a given set of operating conditions and controlling each of the supercharger, the bypass, the CDA system and the throttle body based on the determined operating mode. Also featured are an engine control system for an internal combustion engine having a supercharger, an air bypass, a cylinder de-activation (CDA) system and a throttle body as well as an internal combustion engine embodying such methods and control systems.

In particular embodiments of such methods, such controlling of the supercharger, the air bypass, the CDA system and the throttle body based on the determined operating mode is done so that in one operating mode the supercharger is not operable, the bypass is in an open state, the CDA system is configured so that all cylinders are operational, and the throttle body is controlled as in a normal aspirated engine condition. In addition, such controlling is done so that in a second operating mode the supercharger is not operable, the bypass is in an open state, the CDA system is configured so that one or more cylinders of the engine are in a deactivated state and so that other cylinders remain operable, and the throttle body is controlled as in a CDA engine condition. Also, such controlling is done so that in a third operating mode the supercharger is operable, the bypass is in a closed state, the CDA system is configured so that all cylinders are operational, and the throttle body is controlled in a supercharged engine condition.

In further embodiments, the provided supercharger includes a clutch and in a first operating mode such methods include configuring or setting the clutch so that the supercharger is not operable. In addition, in such a first operating mode such methods also include configuring the bypass so it is an open state, configuring the CDA system so that all cylinders are operational, and controlling the throttle body in a normal aspirated engine condition.

In yet further embodiments, in a second operating mode such methods include configuring or setting the clutch so that the supercharger is not operable, configuring the bypass so it is an open state, configuring the CDA system so that one or more cylinders of the engine are in a deactivated state and so that other cylinders remain operable, and controlling the throttle body in a CDA engine condition.

In yet further embodiments, in a third operating mode such methods include configuring or setting the clutch so that the supercharger is operable, configuring the bypass so it is in a closed state, configuring the CDA system so that all cylinders are operational, and controlling the throttle body in a supercharged engine condition.

In yet further embodiments, in the first operating mode the load is idle or low and the speed is low/high, in the second operating mode the load is low and the speed is low, and in the third operating mode the load is one of high or acceleration and speed is high.

According to another aspect of the present invention, there is featured an engine control system for an internal combustion engine having a supercharger, an air bypass, a cylinder de-activation (CDA) system and a throttle body, wherein the supercharger is configured and arranged so as to be selectively operable. Such an engine control system includes a controller that selectively controls the supercharger, the bypass, and the CDA system and the throttle body. Such a controller also is configured and arranged so as to determine which one of three operating modes is appropriate for a given set of engine operating conditions. In addition such a controller is further configured and arranged so as to control each of the supercharger, the bypass, the CDA system and the throttle body based on the determined operating mode.

In embodiments of the present invention, such a controller is further configured and arranged so that in one operating mode the supercharger is not operable, the bypass is configured so as to be in an open state, the CDA system is configured so that all cylinders are operational, and the throttle body is controlled as for a normal aspirated engine. In addition, such a controller is further configured and arranged so that in a second operating mode the supercharger is not operable, the bypass is in an open state, the CDA system is configured that so that one or more cylinders of the engine are in a deactivated state and that other cylinders remain operable, and the throttle body is controlled in a CDA engine condition. Also, such a controller is further configured and arranged so that in a third operating mode the supercharger is operable, the bypass is in a closed state, the CDA system is configured so that all cylinders are operational, and the throttle body is controlled in a supercharged engine condition.

In particular embodiments, the supercharger includes a clutch and the controller is further configured and arranged so that in a first operating mode the clutch is configured or set so the supercharger is not operable, the bypass is configured so it is an open state, the CDA system is configured so that all cylinders are operational, and the throttle body is controlled as a normally aspirated engine.

In yet further embodiments, the controller is configured and arranged so that in a second operating mode the supercharger is not operable, the bypass is arranged so it is an open state, configuring the CDA system so that one or more cylinders of the engine are in a deactivated state and that other cylinders remain operable, and controlling the throttle body in a CDA engine condition.

In yet further embodiments, such a controller is further configured and arranged so that in a third operating mode the clutch is set so that the supercharger is operable, the bypass is configured/arranged so it is in closed state, the CDA system is configured/arranged so that all cylinders are operational, and the throttle body is controlled as in a supercharged engine condition.

In yet further embodiments, when in the first operating mode the load is idle or low and the speed is low/high, when in the second operating mode the load is low and the speed is low, and when in the third operating mode the load is one of high or acceleration and speed is high.

In yet further embodiments, the controller further includes a processor for controlling operation of the supercharger, the bypass, the CDA system and the throttle body and a software program for execution on the processor for controlling such functionalities. Such a software program includes, code segments, instructions and criteria for: determining which of three operating modes is appropriate for a given set of engine operating conditions; and for controlling each of the supercharger, the bypass, the CDA system and the throttle body based on the determined operating mode.

According to yet another aspect of the present invention, there is featured an internal combustion engine including a plurality of cylinders, a cylinder deactivation (CDA) system, a supercharger that is operably coupled to an air intake, an air bypass and a throttle body. The CDA system is configured and arranged so that valves for certain cylinders are selectively operable between an operating position and a deactivated position, where in the deactivated position a related cylinder is deactivated and so that valves for other remaining cylinders remain operable so that a related operably cylinder is operable. The bypass is configured so as to be selectively operably coupled to the air intake. The throttle body is operably coupled to the air intake line disposed downstream of the bypass and supercharger.

Such an internal combustion engine also includes an engine control system that is operably coupled to each of the CDA system, supercharger, bypass and throttle body. Such an engine control system includes a controller. The controller is configured so as to selectively control the supercharger, the bypass, and the CDA system and the throttle body. Such a controller also is configured and arranged so as to determine which of three operating modes is appropriate for a given set of engine operating conditions. Such a controller also is configured and arranged so as to control each of the supercharger, the bypass, the CDA system and the throttle body based on the determined operating mode.

In particular embodiments of such an internal combustion engine, the controller is further configured and arranged so that: (a) in one operating mode, the supercharger is not operable, the bypass is configured so as to be in an open state, the CDA system is configured so that all cylinders are operational, and the throttle body is controlled as a normally aspirated engine condition; (b) in a second operating mode, the supercharger is not operable, the bypass is configured so as to be in an open state, the CDA system is configured that so that one or more cylinders of the engine are in a deactivated state and so that other cylinders remain operable, and the throttle body is controlled in a CDA engine condition; and (c) in a third operating mode, the supercharger is operable, the bypass is configured so as to be in a closed state, the CDA system is configured so that all cylinders are operational, and the throttle body is controlled in a supercharged engine condition.

In yet further embodiments, the supercharger includes a clutch and the controller is further configured and arranged so that in a first operating mode the clutch is controlled so that the supercharger is not operable, the bypass is controlled or configured so it is in an open state, the CDA system is controlled so that all cylinders are operational, and the throttle body is controlled in a normal aspirated engine condition.

In yet further embodiments, the supercharger includes a clutch and the controller is further configured and arranged so that in a second operating mode: the clutch is controlled so that the supercharger is not operable, the bypass is controlled so it is in an open state, the CDA system is controlled so that one or more cylinders of the engine are in a deactivated state and that other cylinders remain operable, and the throttle body is controlled in a CDA engine condition.

In yet further embodiments, the supercharger includes a clutch and the controller is further configured and arranged so that in a third operating mode, the clutch is controlled so that the supercharger is operable, the bypass is controlled so it is in a closed state, the CDA system is controlled so that all cylinders are operational, and the throttle body is controlled in a supercharged engine condition.

In yet further embodiments, in the first operating mode the load is idle or low and the speed is low/high, in the second operating mode the load is low and the speed is low, and in the third operating mode the load is one of high or acceleration and speed is high.

In yet further embodiments, the controller further includes a processor for controlling operation of the supercharger, the bypass, the CDA system and the throttle body and a software program for execution on the processor. Such a software program includes, code segments, instructions and criteria for determining which of three operating modes is appropriate for a given set of engine operating conditions; and controlling each of the supercharger, the bypass, the CDA system and the throttle body based on the determined operating mode.

In the first and second operating modes, the supercharger is not operable and the bypass is opened. In the third mode, the supercharger is operable and the bypass is closed. In the first and third modes, the CDA system is configured so all cylinders are operational. In the second mode, the CDA system is configured so certain cylinders are in a deactivated state and so other cylinders remain operable.

Other aspects and embodiments of the invention are discussed below.

### Definitions

The instant invention is most clearly understood with reference to the following definitions:

As used in the specification and claims, the singular form “a”, an and the include plural references unless the context clearly dictates otherwise.

As used herein, the term “comprising” or “including” is intended to mean that the compositions, methods, devices, apparatuses and systems include the recited elements, but do not exclude other elements. “Consisting essentially of”, when used to define compositions, devices, apparatuses, systems, and methods, shall mean excluding other elements of any essential significance to the combination. Embodiments defined by each of these transition terms are within the scope of this invention.

USP shall be understood to mean U.S. Patent Number, namely a U.S. patent granted by the U.S. Patent and Trademark Office.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1 is an illustrative view of a conventional internal combustion engine that is configured with a supercharger and showing use of an intercooler;

FIGS. 2A, B are illustrative views of an cylinder block for a V-8 engine, with the cylinder heads removed for clarity and showing 8 cylinder operation (FIG. 2A) and CDA operation with four cylinders (FIG. 2B).

FIG. 3 is an illustrative view of an 8 cylinder internal combustion engine configured with the systems and embodying the methods of the present invention.

FIG. 4 is an illustrative view of a supercharger module of the present invention.

FIG. 5 is an illustrative view with partial cut-away of the supercharger module and air intake according to the present invention.

FIG. 6 is a block diagram of a system according to the present invention.

FIG. 7 is a high level flow diagram of an illustrative methodology of the present invention.

FIG. 8 is a diagrammatic view illustrating exemplary operational characteristics of the various modes of the present invention (BPEP versus engine rpm) illustrating operational ranges for operating in one of the three operating modes of the present invention.

FIG. 9 is a diagrammatic view comparing a V8 engine embodying the methods and devices of the present invention with a corresponding normal aspirated V8 engine.

### DESCRIPTION OF THE PREFERRED EMBODIMENT

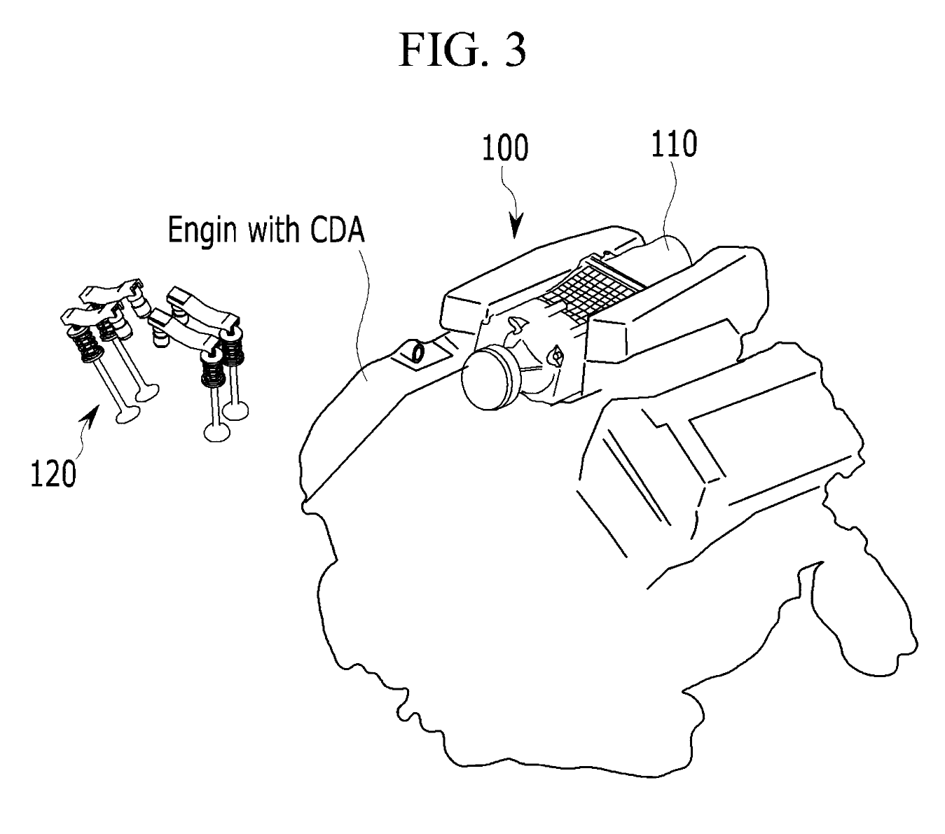

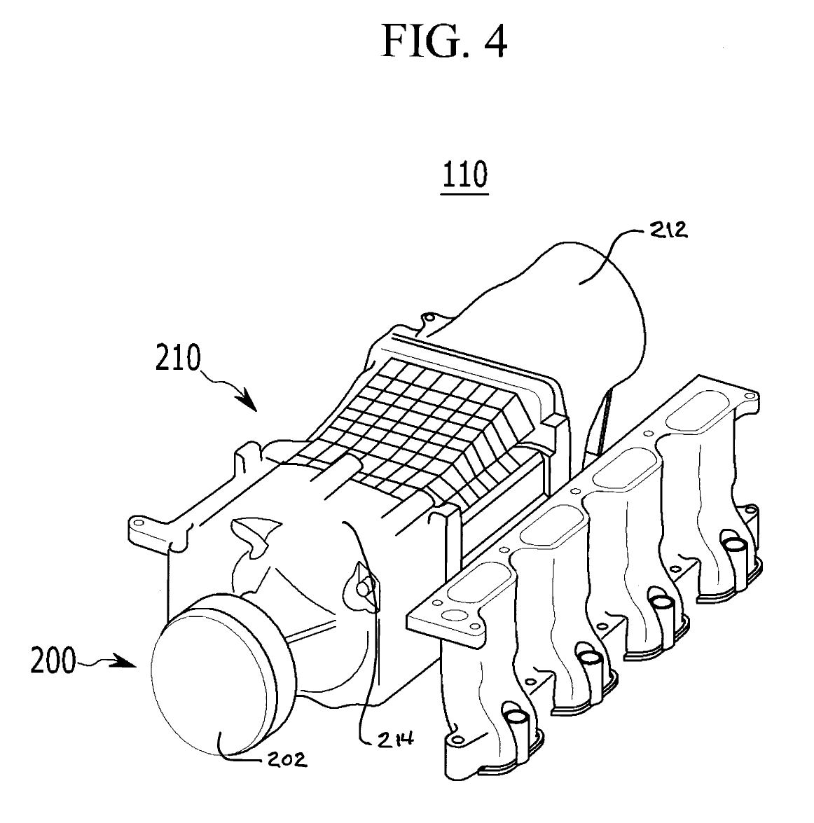

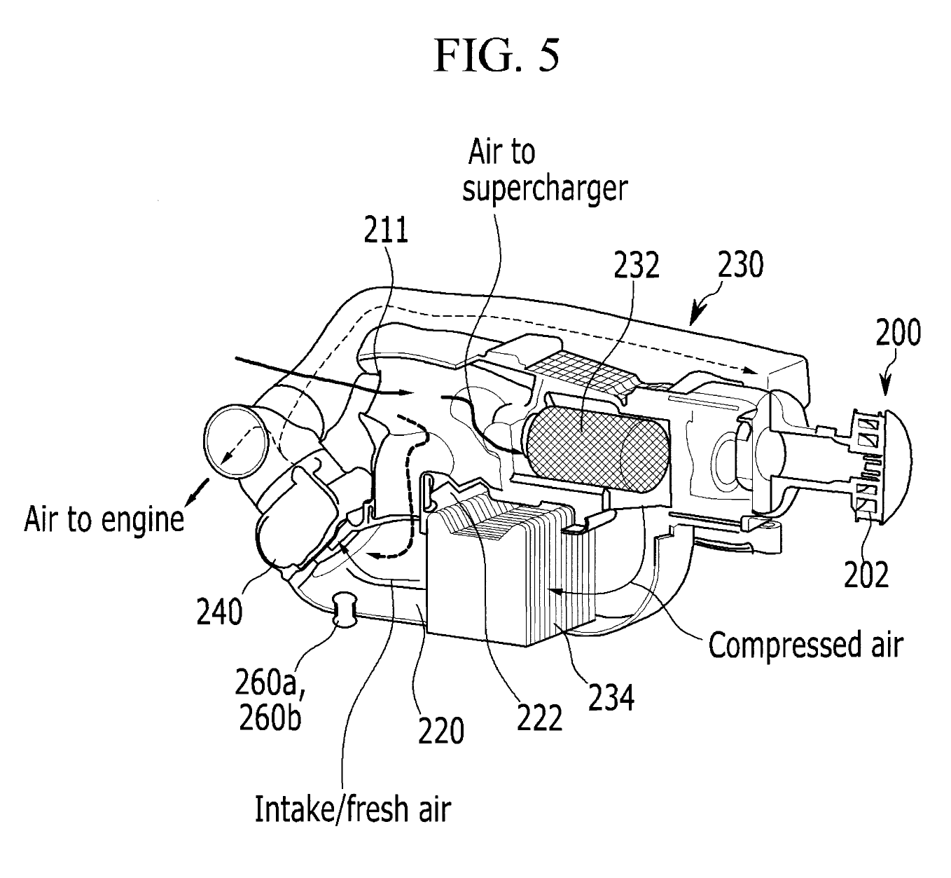

Referring now to the various figures of the drawing wherein like reference characters refer to like parts, there is shown in FIG. 3 an illustrative view of an internal combustion engine 100 that is configured with the systems and embodying the methods of the present invention. Also in FIG. 4 there is shown an illustrative view of a supercharger module 110 of the present invention and in FIG. 5 an illustrative view with partial cut-away of the supercharger module 110 and air intake 112 according to the present invention.

In the illustrated embodiment, the internal combustion engine 100 is an eight cylinder engine in a V configuration (i.e., V-8). This shall not be considered as limiting as such an internal combustion engine is configurable so as to include one or more cylinders more particularly 4 cylinders, 6 cylinders, 8 cylinders, 10 cylinders and 12 cylinders. Also, the cylinders are arranged in the engine so as to be in a line, slanted, to form a V, or arranged in any of a number of ways as one known to those skilled in the art.

The cylinder de-activation (CDA) system embodied in such an internal combustion engine is any of a number of systems know to those skilled in the art, whereby certain of the cylinders can be deactivated and other of the cylinders remain operational (i.e., producing power).

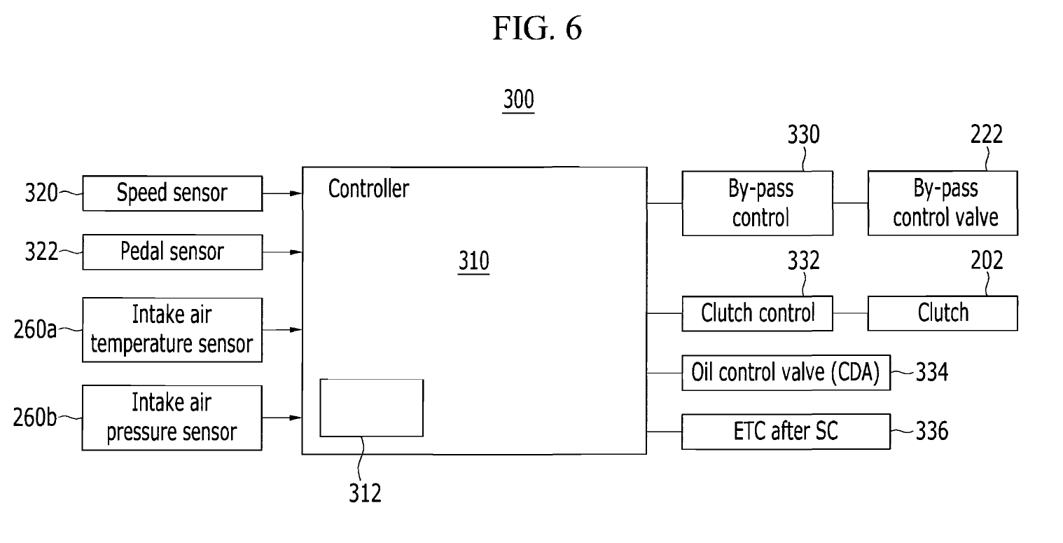

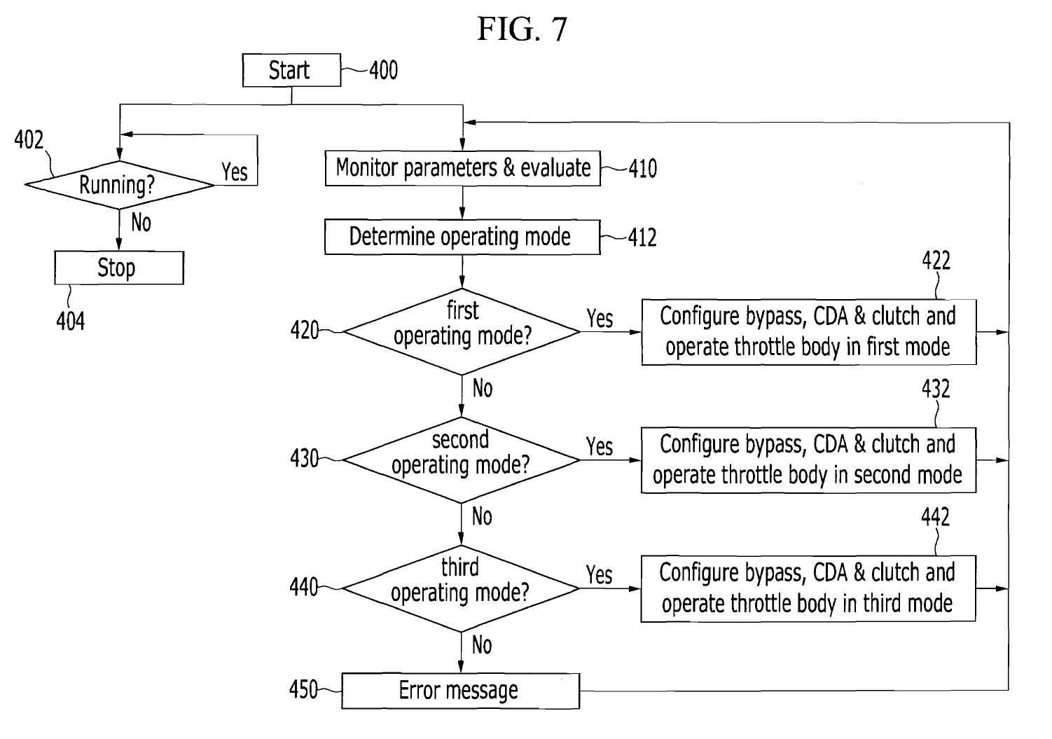

In illustrative embodiments, the intake and exhaust valves 120 of the CDA system of the cylinders embodied in the internal combustion engine 100, that can be deactivated are configured so as to be selectively operable. More particularly, the valvetrains for such engines are provided with switching lifters for actuating the intake and exhaust valves, such as described in US Patent Publication No. 2005/0279320 and U.S. Pat. No. 6,874,463, the teachings of which are incorporated herein by reference. The lifters for the other intake and exhaust valves can be any of a number of lifters known in the art. When activated, the switching lifters operate to deactivate the cylinders so that operation of the selected cylinders is cut out completely. In addition, the fuel to the deactivated cylinders is cut-off. In particular embodiments, a control valve 334 (e.g., a solenoid control valve) is provided to control the oil pressure supplied to the deactivation portion of the switching lifters to change their mode of operation between normal powered operation and non-powered cylinder cut-out. Such operation is more particularly discussed herein in connection with FIGS. 6 and 7.

The supercharger module 112 includes a drive pulley 200 having a clutch 202, a housing 210 including a bypass housing 212 and a housing 214 for the supercharger. The housing 210 includes an air intake 211 that receives fresh air for combustion purposes. The air to the air intake 211 typically passes through a filter (not shown) to remove particulates and the like.

The fresh air passing through the air intake 211, goes in one of two directions. In one case, the air is directed to the air bypass 220 which includes a by-pass valve 222 which would be in an open position. In this way, the bypass air is then communicated to the throttle body 240. As described herein, the bypass valve 222 is opened when the engine is running in the normal aspiration mode or in the CDA mode, however, the bypass valve and thus the air bypass 220 is closed when running in the supercharger operating mode.

The supercharger 230 is operably connected to the drive pulley 200 via a clutch mechanism 202 so that the supercharger can be selectively controlled so as to be in an operating or in a non-operating condition. As described herein, when the supercharger 230 is in the supercharging operating mode, the by-pass valve 222 is closed so that the intake air flows to the inlet of the supercharger rollers 232.

The drive pulley 200 is typically coupled (e.g., mechanically or fluidly coupled) to the crankshaft or other driving device by, for example, a belt (not shown) so that the drive pulley rotates responsive to the movement of the belt. Such a drive pulley 200 and clutch mechanism 202 is well known in the art and thus need not be described with particularly herein.

The clutch mechanism 202 is controlled so as to couple the drive pulley to the supercharger rollers 232 such that rotation of the drive pulley thereby causes the supercharger rollers 232 to rotate. Such rotation of the rollers thereby compresses the intake air so that compressed air is provided to the throttle body 240. When the supercharger is not in an operating condition (no compression of air), the clutch mechanism 202 is controlled so as to mechanically decouple the drive pulley from the supercharger rollers 232, so the rollers do not rotate.

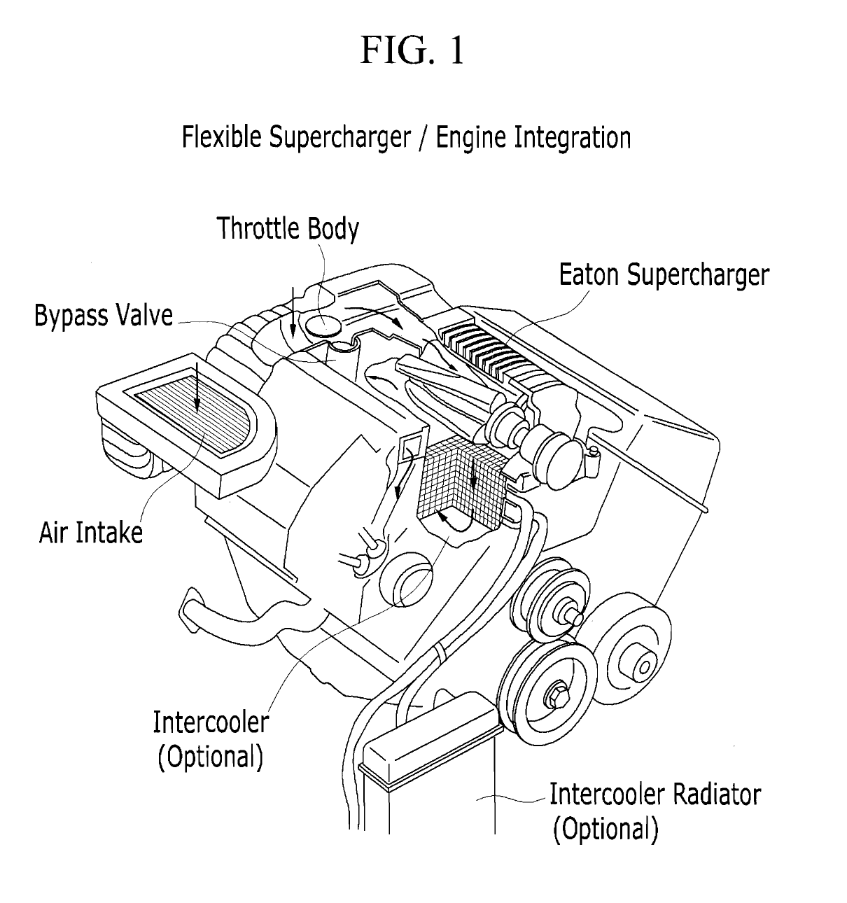

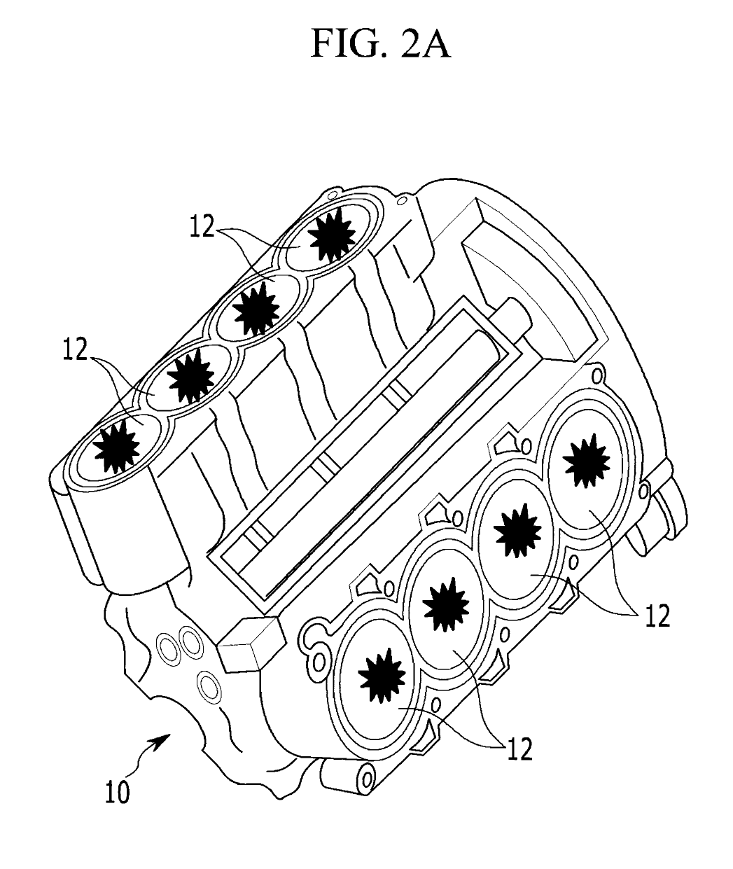

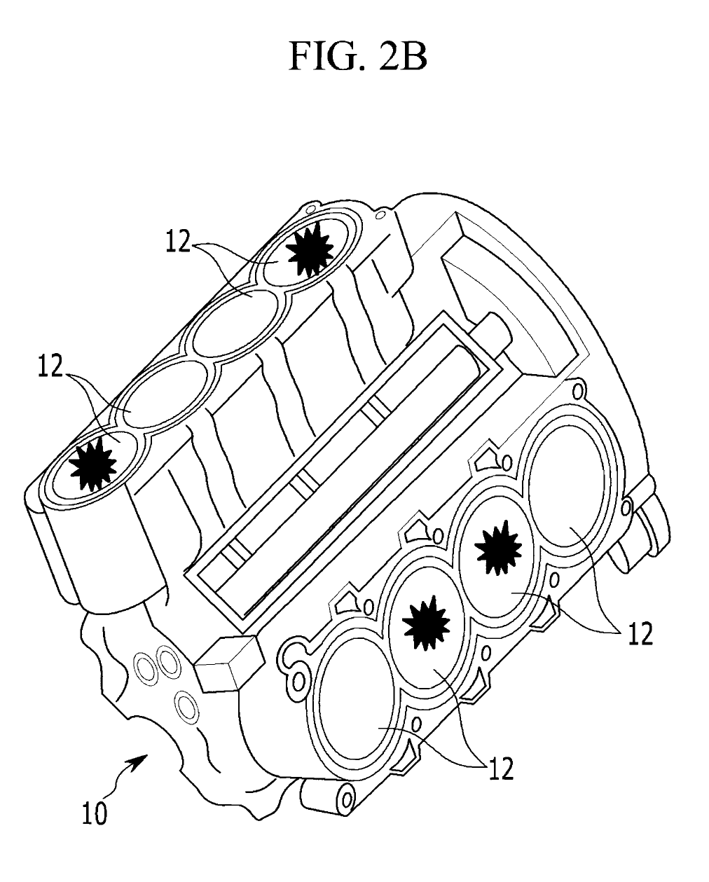

In further embodiments, such a supercharger 230 further includes an intercooler 234 that cools the compressed air. When air is compressed by the supercharger, the temperature of the air is increased above ambient. Such heating may not be desirous from the standpoint of continuous engine operation, and so an intercooler 234 is provided to reduce the temperature of the compressed air. As is shown in FIG. 1, such an intercooler 234 typically is fluidly coupled to a radiator or other heat exchanging type of device so that the heat energy removed from the compressed air is dissipated (e.g., to air).

As is known to those skilled in the art, the throttle body 240 controls the flow of air to the engine cylinders so as to thereby have a control over the combustion process. In the present invention and as described further herein, the throttle body 240 is located down stream of the air by-pass and also down stream of the supercharger. Thus and as indicated herein, the throttle body 240 controls the flow of air, during a normal aspiration mode, a CDA node and when the intake air is being supercharged. This advantageously reduces part count as compared to applications in which a separate throttle body is provided to handle supercharged air.

In further embodiments, temperature and pressure sensors 260a,b are located in the air line upstream of the throttle body 240 so as to sense the temperature and pressure of the air or compressed air going to the throttle body. Such sensors 260a,b are used for determining an appropriate air flow through the throttle body 240. In addition, such sensors are usable as inputs for purposes of controlling the different engine operating modes. In an illustrative embodiment, the temperature and pressure sensors 260a,b are in the form of a combined sensor.

Referring now to FIG. 6 there is shown a control system 300 according to the present invention for determining an appropriate engine operating mode and for controlling the various functionalities so the engine is operating in the desired or appropriate operating mode. Such a control system 300 includes a controller 310 including a processor 312 or other digital processing circuitry (e.g., Application Specific Integrated Circuit (ASIC)) that determines the appropriate engine operating mode and controls various functionalities so the engine is operated in the desired or appropriate operating mode until it is determined that the operating mode needs to be changed. It should be recognized that a vehicle typically includes a plurality or a multiplicity of controllers and thus an existing controller can be adapted to perform the functions described herein for the controller 310. In an illustrative embodiment, the engine control unit is adapted to perform the functions and actions described herein for the controller 310.

A speed sensor 320, a pedal sensor 322 or pedal locator, and the intake air temperature and pressure seniors 260a,b are each operably coupled to the controller 310. Each of these sensors are well known in the art and so they are not described with any particularity further herein. The sensors 320, 322, 260a,b provide inputs to the controller which can be used to determine an appropriate operating mode and to determine if the operating modes should be changed. In additions such sensed parameters, where appropriate, can be used in controlling the throttle body 240.

The controller 310 also is operably coupled to a bypass control 330 or controller, a clutch control 332 or controller, the oil control valve 334 that controls the switchable lifters of a CDA system, and the electric throttle controller 336 for the throttle body. The bypass control 330 is operably coupled to the bypass control valve 222 so as to thereby selectively control the opening and closing of the valve. The clutch control 332 is operably coupled to the clutch mechanism 202 so as to thereby selectively control the engagement and dis-engagement of the clutch. The electric throttle control (ETC) controls the throttle body based on the determined operating mode and the operation dictated by the driver (e.g., via pedal location).

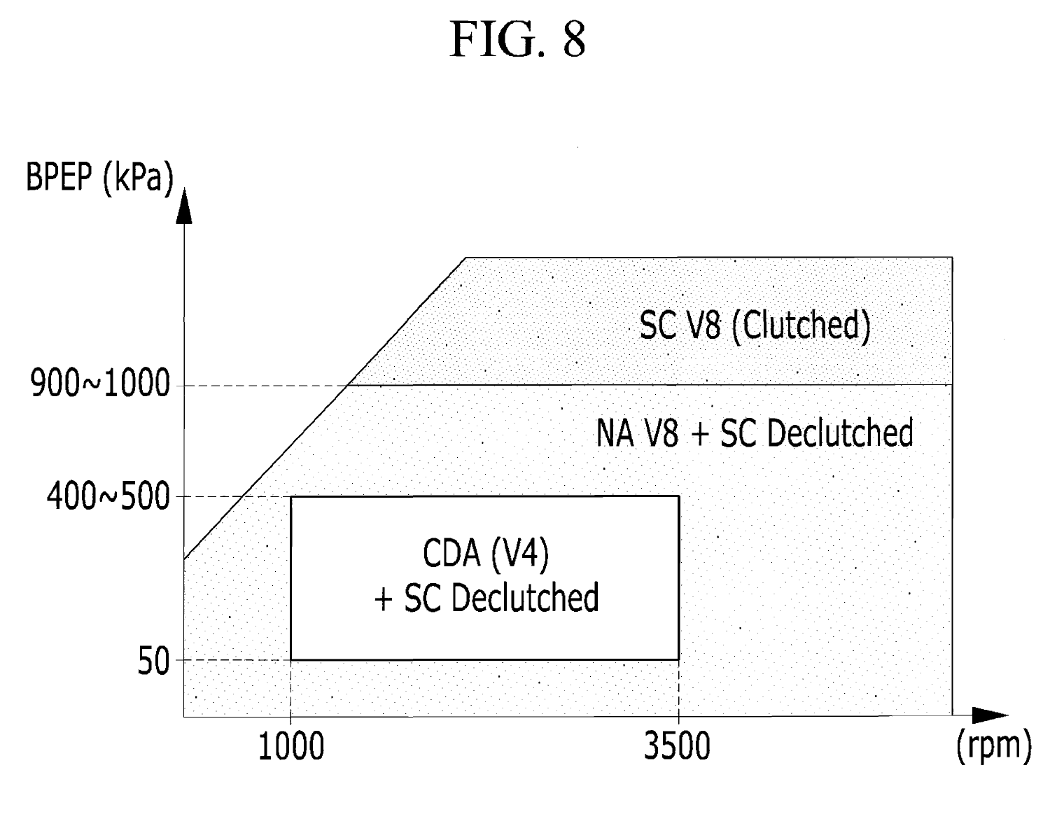

Referring now to FIG. 7, there is shown a high level flow diagram of an illustrative methodology of the present invention. Reference also shall be made to FIGS. 3-6 for features that are not otherwise shown in FIG. 7. Reference also should be made to FIG. 8 which is a diagrammatic view illustrating exemplary operational characteristics of the various modes of the present invention (BPEP versus engine rpm) and which more particularly illustrates operational ranges for operating in one of the three operating modes of the present invention.

The flow chart herein illustrates the structure of the logic of the different methodologies/inventions, which can be embodied in computer program software for execution on a computer, digital processor or microprocessor. Those skilled in the art will appreciate that the flow chart illustrate the structures of the computer program code elements, including logic circuits on an integrated circuit, that function according to the present inventions. As such, the present inventions are practiced in its essential embodiments by a machine component that renders the program code elements in a form that instructs a digital processing apparatus (e.g., computer) to perform a sequence of function step(s) corresponding to those shown in the flow diagrams.

After the engine is started and the vehicle is otherwise in an operational condition, the process starts 400 and continues to monitor the running status of the engine/vehicle 402. If the engine 100 is stopped or turned off, the process also is stopped 404.

After the process is started the controller 310 continues to monitor the various input parameters to determine if the current operating mode should be changed, Step 410. It should be recognized that when the vehicle is initially started and begins operation, the engine 100 is operated in the normal aspirated mode, corresponding to the first operating mode. Thereafter, an evaluation is made with regards to the current operating mode being implemented. If it is determined that the current engine operating mode should be changed, then the controller 310 determines what engine operating mode is appropriate for the current engine and vehicle operating conditions, Step 412.

Specifically, the controller 310 evaluates the parameters to determine if the engine should be operating in the first operating mode, Step 420. For example, if the engine is operating in the second or CDA operating mode, do the parameters being evaluated when compared with the various criterion for the other two modes, indicate that the operating mode should be changed to either the first or third operating mode.

In particular embodiments, an evaluation is made with respect to the graphical information contained in FIG. 8 to determine if the monitored conditions are such that the engine is operating in the range of conditions shown in FIG. 8 for Mode B or Mode 1. Alternatively, an evaluation is made to determine if the load is high and/or the speed is low/high, corresponding to operational conditions for operating the engine in the first operating mode. If it is determined that the operational conditions correspond to the first operating mode (YES, Step 420) then the bypass air line 220, the CDA system and clutch mechanism 202 are configured to correspond to the appropriate configurations, Step 422. More particularly, the bypass valve 222 is opened so the bypass line is open, the CDA system is set off (i.e., the oil valve 334 is put into the appropriate condition so the CDA related lifters are in-active) and the clutch 202 is set off or de-clutched so the supercharger 230 is not operating. In addition, the throttle body 240 is operated in the normal aspirated mode or the first operating mode. Thereafter, the process returns to monitoring parameters at step 410.

If it is determined that the operational conditions do not correspond to the first operating mode (NO, Step 420), then the controller 310 evaluates the parameters to determine if the engine should be operating in the second operating mode, Step 430. In particular embodiments, an evaluation is made with respect to the graphical information contained in FIG. 8 to determine if the monitored conditions are such that the engine is operating in the range of conditions shown in FIG. 8 for Mode A or Mode 2. Alternatively, an evaluation is made to determine if the load is low and/or the speed is low, corresponding to operational conditions for operating the engine in the second operating mode. If it is determined that the operational conditions correspond to the second operating mode (YES, Step 430) then the bypass air line 220, the CDA system and clutch mechanism 202 are configured to correspond to the appropriate configurations, Step 432. More particularly, the bypass valve 222 is opened so the bypass line is open, the CDA system is set on (i.e., the oil valve is 334 put into the appropriate condition so all the lifters are all active) and the clutch 202 is set off or de-clutched so the supercharger 230 is not operating. In addition, the throttle body 240 is operated in the CDA mode or second operating mode. Thereafter, the process returns to monitoring parameters at step 410.

If it is determined that the operational conditions do not correspond to the second operating mode (NO, Step 430), then the controller 310 evaluates the parameters to determine if the engine should be operating in the third operating mode, Step 440. In particular embodiments, an evaluation is made with respect to the graphical information contained in FIG. 8 to determine if the monitored conditions are such that the engine is operating in the range of conditions shown in FIG. 8 for Mode C or Mode 3. Alternatively, an evaluation is made to determine if the load is high and/or with acceleration and/or the speed is high, corresponding to operational conditions for operating the engine in the third operating mode. If it is determined that the operational conditions correspond to the third operating mode (YES, Step 440) then the bypass air line 220, the CDA system and clutch mechanism 202 are configured to correspond to the appropriate configurations, Step 442. More particularly, the bypass valve 222 is closed so the bypass line is closed, the CDA system is set off (i.e., the oil valve 334 is put into the appropriate condition so the CD related lifters are in-active) and the clutch 202 is set on or clutched so the supercharger 230 is operating. In addition, the throttle body 240 is operated in the supercharged mode or the third operating mode. Thereafter, the process returns to monitoring parameters at step 410.

If it is determined that the operational conditions do not correspond to the third operating mode (NO, Step 440) and thus also do not correspond to the first or second operating modes (NO, Steps 420, 430), then the system returns and error message 450 and the engine continues to operated in the current operating mode. Thereafter, the process returns to monitoring parameters at step 410 to determine if the current operating mode should be changed.

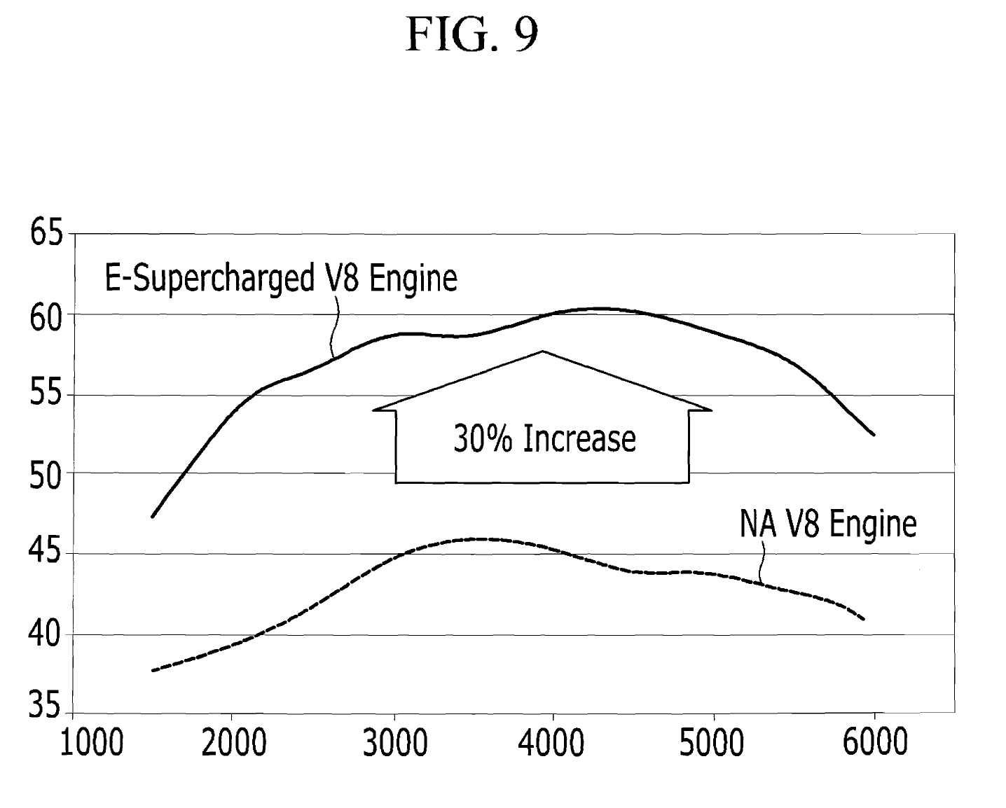

Referring now to FIG. 9 there is shown a diagrammatic view that compares a V8 engine embodying the methods and devices of the present invention with a normal aspirated V8 engine. As shown, a V-8 engine embodying the systems and methods of the present invention shows about 30% increase in performance as compared to a conventional normally aspirated engine. In addition, engine dyno results indicate that such an engine of the present invention also would increase overall fuel efficiency about 8% as compared to a conventional normally aspirated V-8 engine and about 12% as compared to a conventional V-8 supercharged engine. In addition, the systems and methods of the present invention, advantageously maximize engine performance at highload/high speed and minimize fuel consumption at lowload/low speed.

Although a preferred embodiment of the invention has been described using specific terms, such description is for illustrative purposes only, and it is to be understood that changes and variations may be made without departing from the spirit or scope of the following claims.

### Incorporation by Reference

All patents, published patent applications and other references disclosed herein are hereby expressly incorporated by reference in their entireties by reference.

### Equivalents

Those skilled in the art will recognize, or be able to ascertain using no more than routine experimentation, many equivalents of the specific embodiments of the invention described herein. Such equivalents are intended to be encompassed by the following claims.

What is claimed is:

1. A method for controlling operation of an internal combustion engine, said method comprising the steps of:
providing an internal combustion engine having a supercharger, a bypass, a cylinder de-activation (CDA) system and a throttle body, wherein the supercharger is configured and arranged so as to be selectively operable;
determining which of three operating modes is appropriate for a given set of engine operating conditions; and
controlling each of the supercharger, the bypass, the CDA system and the throttle body based on the determined operating mode.

2. The method of claim 1, wherein:
the provided supercharger includes a clutch;
in a first operating mode the method further includes the steps of:
setting the clutch so that the supercharger is not operable,
configuring the bypass so it is an open state,
configuring the CDA system so that all cylinders are operational, and
controlling the throttle body as for a normally aspirated engine.

3. The method of claim 1, wherein:
the provided supercharger includes a clutch;
in a second operating mode the method further includes the steps of:
setting the clutch so that the supercharger is not operable,
configuring the bypass so it is an open state,
configuring the CDA system so that one or more cylinders of the engine are in a deactivated state and so that other cylinders remain operable, and
controlling the throttle body in a CDA engine condition.

4. The method of claim 1, wherein:
the provided supercharger includes a clutch;
in a third operating mode the method further includes the steps of:
setting the clutch so that the supercharger is operable,
configuring the bypass so it is in a closed state,
configuring the CDA system so that all cylinders are operational, and
controlling the throttle body in a supercharged engine condition.

5. The method of claim 1, wherein:
in one operating mode:
the supercharger is not operable,
the bypass is in an open state,
the CDA system is configured so that all cylinders are operational, and
the throttle body is controlled in a normal aspirated engine condition.
in a second operating mode:
the supercharger is not operable,
the bypass is in an open state,
the CDA system is configured that so that one or more cylinders of the engine are in a deactivated state and that other cylinders remain operable, and
the throttle body is controlled in a CDA engine condition; and
in a third operating mode:
the supercharger is operable,
the bypass is in a closed state,
the CDA system is configured so that all cylinders are operational, and
the throttle body is controlled in a supercharged engine condition.

6. The method of claim 1, wherein:
in the first operating mode the load is idle or low and the speed is low/high,
in the second operating mode the load is low and the speed is low, and
in the third operating mode the load is one of high or acceleration and speed is high.

7. An engine control system for an internal combustion engine having a supercharger, a bypass, a cylinder de-activation (CDA) system and a throttle body, wherein the supercharger is configured and arranged so as to be selectively operable, said system comprising:
a controller, the controller selectively controlling the supercharger, the bypass, the CDA system and the throttle body;
wherein the controller is configured and arranged so as to determine which of three operating modes is appropriate for a given set of engine operating conditions; and
wherein the controller is further configured and arranged so as to control each of the supercharger, the bypass, the CDA system and the throttle body based on the determined operating mode.

8. The engine control system of claim 7, wherein the controller is further configured and arranged so that:
in one operating mode:
the supercharger is not operable,
the bypass is in an open state,
the CDA system is configured so that all cylinders are operational, and
the throttle body is controlled in a normal aspirated engine condition;
in a second operating mode:
the supercharger is not operable,
the bypass is in an open state,
the CDA system is configured that so that one or more cylinders of the engine are in a deactivated state and that other cylinders remain operable, and
the throttle body is controlled in a CDA engine condition; and
in a third operating mode:
the supercharger is operable,
the bypass is in a closed state,
the CDA system is configured so that all cylinders are operational, and
the throttle body is controlled in a supercharged engine condition.

9. The engine control system of claim 7, wherein the supercharger includes a clutch and wherein the controller is further configured and arranged so that in a first operating mode:
the clutch is controlled so that the supercharger is not operable,
the bypass is controlled so it is in an open state,
the CDA system is controlled so that all cylinders are operational, and
the throttle body is controlled in a normal aspirated engine condition.

10. The engine control system of claim 7, wherein the supercharger includes a clutch and wherein the controller is further configured and arranged so that in a second operating mode:
the clutch is controlled so that the supercharger is not operable,
the bypass is controlled so it is in an open state,
the CDA system is controlled so that one or more cylinders of the engine are in a deactivated state and that other cylinders remain operable, and
the throttle body is controlled in a CDA engine condition.

11. The engine control system of claim 7, wherein the supercharger includes a clutch and wherein the controller is further configured and arranged so that in a third operating mode:
the clutch is controlled so that the supercharger is operable,
the bypass is controlled so it is in a closed state,
the CDA system is controlled so that all cylinders are operational, and
the throttle body is controlled in a supercharged engine condition.

12. The engine control system of claim 7, wherein:
in the first operating mode the load is idle or low and the speed is low/high,
in the second operating mode the load is low and the speed is low, and
in the third operating mode the load is one of high or acceleration and speed is high.

13. The engine control system of claim 7, wherein the controller further includes a processor for controlling operation of the supercharger, the bypass, the CDA system and the throttle body and a software program for execution on the processor; and
where said software program includes, code segments, instructions and criteria for:
determining which of three operating modes is appropriate for a given set of engine operating conditions; and
controlling each of the supercharger, the bypass, the CDA system and the throttle body based on the determined operating mode.

14. An internal combustion engine comprising:
a plurality of cylinders;
a cylinder deactivation (CDA) system that is configured so that valves for certain cylinders are selectively operable between an operating position and a deactivated position, where in the deactivated position a related cylinder is deactivated and so that other remaining valves remain operable so that a related cylinder is operable;
a supercharger operably coupled to an air intake;
a bypass that is configured so as to be selectively operably coupled to the air intake;
a throttle body that is operably coupled to an air intake line disposed downstream of the bypass and supercharger;
an engine control system that is operably coupled to each of the CDA system, supercharger, bypass and throttle body;
wherein the engine control system includes:
a controller, the controller selectively controlling the supercharger, the bypass, the CDA system and the throttle body;
wherein the controller is configured and arranged so as to determine which of three operating modes is appropriate for a given set of engine operating conditions; and
wherein the controller is further configured and arranged so as to control each of the supercharger, the bypass, the CDA system and the throttle body based on the determined operating mode.

15. The internal combustion engine of claim 14, wherein the controller is further configured and arranged so that:
in one operating mode:
the supercharger is not operable,
the bypass is in an open state,
the CDA system is configured so that all cylinders are operational, and
the throttle body is controlled in a normal aspirated engine condition.
in a second operating mode:
the supercharger is not operable,
the bypass is in an open state,
the CDA system is configured that so that one or more cylinders of the engine are in a deactivated state and that other cylinders remain operable, and
the throttle body is controlled in a CDA engine condition; and
in a third operating mode:
the supercharger is operable,
the bypass is in a closed state,
the CDA system is configured so that all cylinders are operational, and
the throttle body is controlled in a supercharged engine condition.

16. The internal combustion engine of claim 14, wherein the supercharger includes a clutch and wherein the controller is further configured and arranged so that in a first operating mode:
the clutch is controlled so that the supercharger is not operable,
the bypass is controlled so it is in an open state,
the CDA system is controlled so that all cylinders are operational, and
the throttle body is controlled in a normal aspirated engine condition.

17. The internal combustion engine of claim 14, wherein the supercharger includes a clutch and wherein the controller is further configured and arranged so that in a second operating mode:
the clutch is controlled so that the supercharger is not operable,
the bypass is controlled so it is in an open state,
the CDA system is controlled so that one or more cylinders of the engine are in a deactivated state and that other cylinders remain operable, and
the throttle body is controlled in a CDA engine condition.

18. The internal combustion engine of claim 14, wherein the supercharger includes a clutch and wherein the controller is further configured and arranged so that in a first operating mode:
the clutch is controlled so that the supercharger is operable,
the bypass is controlled so it is in a closed state,
the CDA system is controlled so that all cylinders are operational, and
the throttle body is controlled in a supercharged engine condition.

19. The internal combustion engine of claim 14, wherein:
in the first operating mode the load is idle or low and the speed is low/high,
in the second operating mode the load is low and the speed is low, and
in the third operating mode the load is one of high or acceleration and speed is high.

20. The internal combustion engine of claim 14, wherein the controller further includes a processor for controlling operation of the supercharger, the bypass, the CDA system and the throttle body and a software program for execution on the processor; and
where said software program includes, code segments, instructions and criteria for:
determining which of three operating modes is appropriate for a given set of engine operating conditions; and
controlling each of the supercharger, the bypass, the CDA system and the throttle body based on the determined operating mode.
